(19) United States
(12) Patent Application Publication
(10) Pub. No.: US 2026/0081166 A1
(43) Pub. Date: Mar. 19, 2026

(54) CURED PRODUCT FOR LITHIUM ION SECONDARY BATTERIES, NEGATIVE ELECTRODE FOR LITHIUM ION SECONDARY BATTERIES, AND LITHIUM ION SECONDARY BATTERY

(71) Applicant: TDK CORPORATION, Tokyo (JP)

(72) Inventors: Tomomi IWAMOTO, Tokyo (JP); Atsushi MONDEN, Tokyo (JP); Yuka MASUDA, Tokyo (JP); Hiroshi SASAGAWA, Tokyo (JP)

(73) Assignee: TDK CORPORATION, Tokyo (JP)

(21) Appl. No.: 19/110,725

(22) PCT Filed: Jun. 14, 2023
(86) PCT No.: PCT/JP2023/022071

§ 371 Date: Mar. 11, 2025

(30) Foreign Application Priority Data
Sep. 13, 2022 (JP) 2022-145039

(51) Int. Cl. H01M 4/62; H01M 10/0525

(52) U.S. Cl. CPC H01M 4/622; H01M 10/0525

(57) ABSTRACT

A cured product for lithium ion secondary batteries includes water-soluble polymers, a crosslinking agent and cellulose nanofibers. The crosslinking agent crosslinks different water-soluble polymers or the water-soluble polymer and the cellulose nanofibers. When wide-angle X-ray scattering (WAXS) measurement is performed using CuKα rays, the diffraction angle 2θ has a peak in a range of 16° or more and 21° or less. The half-value width of the peak is 5.5° or less.

### TECHNICAL FIELD

The present invention relates to a cured product for lithium ion secondary batteries, a negative electrode for lithium ion secondary batteries and a lithium ion secondary battery. Priority is claimed on Japanese Patent Application No. 2022-145039, filed Sep. 13, 2022, the content of which is incorporated herein by reference.

### BACKGROUND ART

Lithium ion secondary batteries are widely used as power sources for mobile devices such as mobile phones and notebook computers, and hybrid cars.

The capacity of lithium ion secondary batteries mainly depends on active materials of electrodes. Graphite is often used as a negative electrode active material, but a negative electrode active material having a higher capacity than graphite is required. Therefore, silicon (Si) having a theoretical capacity much larger than a theoretical capacity (372 mAh/g) of graphite is focused upon.

A negative electrode active material containing Si undergoes large volume expansion during charging. The volume expansion of the negative electrode active material causes deterioration of cycle characteristics of batteries. When the negative electrode active material undergoes volume expansion, for example, cracks may occur in the negative electrode active material, peeling occurs at the interface between a negative electrode active material layer and a current collector, cracks may occur in a solid electrolyte interphase (SET) coating, and an electrolytic solution may be decomposed. These may deteriorate cycle characteristics of batteries.

For example, Patent Document 1 describes a slurry composition containing carboxymethyl group-containing cellulose ethers and cellulose nanofibers. Patent Document 1 describes that, when cellulose nanofibers and a rubber component are combined, electrodes become flexible, and cycle characteristics of batteries are improved.

### CITATION LIST

### Patent Document

Patent Document 1: WO 2018/135352

### SUMMARY OF INVENTION

### Technical Problem

Further improvements in cycle characteristics are required.

The present disclosure has been made in view of the above circumstances, and an object of the present disclosure is to provide a cured product for lithium ion secondary batteries that can improve cycle characteristics of lithium ion secondary batteries.

### Solution to Problem

In order to achieve the above object, the following aspects are provided.
(1) A cured product for lithium ion secondary batteries according to a first aspect includes water-soluble polymers, a crosslinking agent and cellulose nanofibers. The crosslinking agent crosslinks different water-soluble polymers or the water-soluble polymer and the cellulose nanofibers. In the cured product for lithium ion secondary batteries, when wide-angle X-ray scattering (WAXS) measurement is performed using CuKα rays, the diffraction angle 2θ has a peak in a range of 16° or more and 21° or less. The half-value width of the peak is 5.5° or less.
(2) In the cured product for lithium ion secondary batteries according to the above aspect, the water-soluble polymer may be any one selected from the group consisting of polyvinyl alcohol, carboxymethyl cellulose, methyl cellulose, a copolymer of acrylic acid and vinyl alcohol, and polyacrylic acid.
(3) In the cured product for lithium ion secondary batteries according to the above aspects, the crosslinking agent may be a compound obtained by dissociating a blocking agent from any one selected from the group consisting of a blocked isocyanate silane compound, a blocked diisocyanate compound, and a blocked triisocyanate compound or a titanium compound.
(4) In the cured product for lithium ion secondary batteries according to the above aspects, the water-soluble polymer may have a weight average molecular weight of 9,000 or more and 200,000 or less.
(5) A negative electrode for lithium ion secondary batteries according to a second aspect including a negative electrode active material and the cured product for secondary batteries according to the above aspects.
(6) A lithium ion secondary battery according to a third aspect includes the negative electrode for lithium ion secondary batteries according to the above aspect, a positive electrode, and a separator between the negative electrode for lithium ion secondary batteries and the positive electrode.

### Effects of Invention

The cured product for lithium ion according to the above aspect improves cycle characteristics of lithium ion secondary batteries.

### BRIEF DESCRIPTION OF DRAWINGS

FIG. 1 A schematic view of a lithium ion secondary battery according to a first embodiment.

FIG. 2 A schematic view of a binder according to the first embodiment.

FIG. 3 A schematic view of binder according to the first embodiment before crosslinking.

FIG. 4 An example of wide-angle X-ray scattering (WAXS) measurement results of the binder according to the first embodiment.

### DESCRIPTION OF EMBODIMENTS

Embodiments will be appropriately described below in detail with reference to the drawings. In the drawings used in the following description, in order to facilitate understanding features, feature parts are enlarged for convenience of illustration in some cases, and size ratios and the like between components may be different from those of actual components. Materials, sizes and the like exemplified in the following description are examples not limiting the present invention, and they can be appropriately changed and implemented without departing from the scope and spirit of the invention.

### “Lithium Ion Secondary Battery”

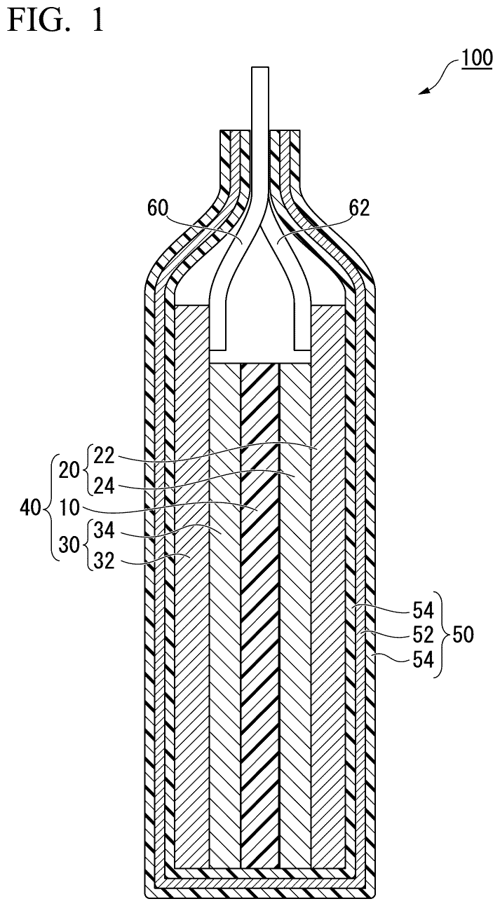

FIG. 1 is a schematic view of a lithium ion secondary battery according to a first embodiment. A lithium ion secondary battery 100 shown in FIG. 1 includes a power generating element 40, an exterior body 50, and a non-aqueous electrolytic solution (not shown). The exterior body 50 covers the periphery of the power generating element 40. The power generating element 40 is connected to the outside via a pair of terminals 60 and 62 connected to the power generating element 40. The non-aqueous electrolytic solution is accommodated in the exterior body 50. FIG. 1 shows an example in which one power generating element 40 is provided in the exterior body 50, but a plurality of power generating elements 40 may be laminated in the exterior body 50. In addition, the lithium ion secondary battery 100 may be of any type, such as a cylindrical type, a rectangular type, a laminate type, or a button type.

### (Power Generating Element)

The power generating element 40 includes a separator 10, a positive electrode 20 and a negative electrode 30.

### <Positive Electrode>

The positive electrode 20 includes, for example, a positive electrode current collector 22 and a positive electrode active material layer 24. The positive electrode active material layer 24 is in contact with at least one surface of the positive electrode current collector 22.

### [Positive Electrode Current Collector]

The positive electrode current collector 22 is, for example, a conductive plate material. The positive electrode current collector 22 is, for example, a thin metal plate made of aluminum, copper, nickel, titanium, stainless steel or the like. Aluminum, which is light in weight, is preferably used for the positive electrode current collector 22. The average thickness of the positive electrode current collector 22 is, for example, 10 μm or more and 30 μm or less.

### [Positive Electrode Active Material Layer]

The positive electrode active material layer 24 contains, for example, a positive electrode active material. The positive electrode active material layer 24 may contain, as necessary, a conductive assistant and a binder.

The positive electrode active material includes an electrode active material that can reversibly absorb and release lithium ions, desorb and insert lithium ions (intercalation), or dope and de-dope lithium ions and counter anions.

The positive electrode active material is, for example, a complex metal oxide. Examples of complex metal oxides include lithium cobalt oxide (LiCoO₂), lithium nickel oxide (LiNiO₂), lithium manganese oxide (LiMnO₂), lithium manganese spinel (LiMn₂O₄), compounds represented by the general formula: LiNiₓCo_{y}Mn_{z}MₐO₂ (in the general formula, x+y+z+a=1, 0≤x<1, 0≤y<1, 0≤z<1, 0≤a<1, and M is one or more elements selected from among Al, Mg, Nb, Ti, Cu, Zn, and Cr), lithium vanadium compounds (LiV₂O₅), olivine type LiMPO₄ (where M is one or more elements selected from among Co, Ni, Mn, Fe, Mg, Nb, Ti, Al, and Zr or VO), lithium titanate (Li₄Ti₅O₁₂), and LiNiₓCo_{y}Al_{z}O₂ (0.9<x+y+z<1.1). The positive electrode active material may be an organic material. The positive electrode active material may be, for example, a polyacetylene, polyaniline, polypyrrole, polythiophene, or polyacene.

The positive electrode active material may be a lithium-free material. Examples of lithium-free materials include FeF₃, conjugated polymers containing an organic conductive substance, Chevrel phase compounds, transition metal chalcogenides, vanadium oxides, and niobium oxides. The lithium-free materials may be used alone or a plurality thereof may be used in combination. When the positive electrode active material is a lithium-free material, for example, discharging is performed first. Lithium is inserted into the positive electrode active material by discharging. In addition, lithium may be pre-doped chemically or electrochemically into the positive electrode active material which does not contain lithium.

The conductive assistant increases the electron conductivity between the positive electrode active materials. Examples of conductive assistants include carbon powders, carbon nanotubes, carbon materials, metal fine powders, mixtures of carbon materials and metal fine powders, and conductive oxides. Examples of carbon powders include carbon black, acetylene black, and ketjen black. Examples of metal fine powders include copper, nickel, stainless steel, and iron powders.

The content of the conductive assistant in the positive electrode active material layer 24 is not particularly limited. For example, the content of the conductive assistant with respect to a total mass of the positive electrode active material, the conductive assistant, and the binder is 0.5 mass % or more and 20 mass % or less, and preferably 1 mass % or more and 5 mass % or less.

The binder in the positive electrode active material layer 24 binds the positive electrode active material together. Any known binder can be used. In addition, the binder may be the same as that used in a negative electrode active material layer 34 to be described below. The binder is preferably one that does not dissolve in an electrolytic solution, has oxidation resistance, and has adhesion. The binder is, for example, a fluorine resin. Examples of binders include polyvinylidene fluoride (PVDF), polytetrafluoroethylene (PTFE), polyamide (PA), polyimide (PI), polyamideimide (PAI), polybenzimidazole (PBI), polyethersulfone (PES), polyacrylic acid and its copolymers, metal ion crosslinked components of polyacrylic acid and its copolymers, maleic anhydride-grafted polypropylene (PP) or polyethylene (PE), and mixtures thereof. The binder used in the positive electrode active material layer is particularly preferably PVDF.

The content of the binder in the positive electrode active material layer 24 is not particularly limited. For example, the content of the binder with respect to a total mass of the positive electrode active material, the conductive assistant, and the binder is 1 mass % or more and 15 mass % or less, and preferably 1.5 mass % or more and 5 mass % or less. When the content of the binder is low, the adhesive strength of the positive electrode 20 is weakened. Since the binder is electrochemically inactive and does not contribute to the discharging capacity, if the content of the binder is large, the energy density of the lithium ion secondary battery 100 decreases.

### <Negative Electrode>

The negative electrode 30 includes, for example, a negative electrode current collector 32 and the negative electrode active material layer 34. The negative electrode active material layer 34 is formed on at least one surface of the negative electrode current collector 32. The negative electrode 30 is an example of a negative electrode for lithium ion secondary batteries.

### [Negative Electrode Current Collector]

The negative electrode current collector 32 is, for example, a conductive plate material. As the negative electrode current collector 32, the same one as the positive electrode current collector 22 can be used.

### [Negative Electrode Active Material Layer]

The negative electrode active material layer 34 contains a negative electrode active material and a binder. The negative electrode active material layer 34 may contain, as necessary, a conductive assistant. The binder is an example of a cured product for lithium ion secondary batteries.

The negative electrode active material contains silicon or a silicon compound. Examples of silicon compounds include silicon alloys and silicon oxides. For example, silicon or a silicon compound may be crystalline, amorphous, or one in which a crystalline component is dispersed in an amorphous component. Amorphous silicon or a silicon compound can be prepared by a melt-spun method, a gas atomizing method or the like. The negative electrode active material may be any known material other than silicon or a silicon compound.

A silicon alloy is represented by XₙSi. X is a cation. X is, for example, Ba, Mg, Al, Zn, Sn, Ca, V, Cr, Mn, Fe, Co, Ni, Cu, Zn, Ge, Y, Zr, Nb, Mo, W, Au, Ti, Na, K or the like. n satisfies 0≤n≤0.5. A silicon oxide is represented by SiOₓ. x satisfies, for example, 0.8≤x≤2. The silicon oxide may be composed of only SiO₂ or only SiO, or may be a mixture of SiO and SiO₂. In addition, in the silicon oxide, some oxygen atoms may be deficient.

The negative electrode active material may be a composite of silicon or a silicon compound. In the composite, at least a part of the surface of silicon or silicon compound particles is coated with a conductive material. Examples of conductive materials include carbon materials, Al, Ti, Fe, Ni, Cu, Zn, Ag, and Sn. For example, the silicon-carbon composite material (Si—C) is an example of a composite. For example, the amount of the conductive material coated on silicon or silicon compound particles with respect to a total mass of the composite is 0.01 mass % or more and 30 mass % or less, and preferably 0.1 mass % or more and 20 mass % or less. The composite can be prepared by, for example, a mechanical alloying method, a chemical vapor deposition method wet method, or a method of applying polymers and then thermally decomposing the polymers into carbon.

The specific surface area of the negative electrode active material determined by a BET method is, for example, 0.5 m²/g or more and 100 m²/g or less, and preferably 1.0 m²/g or more and 20 m²/g or less. If the specific surface area is small, it becomes difficult for Li ions to be inserted into and desorbed from the negative electrode active material. If the specific surface area is large, a large amount of the binder is required to form an electrode, and the capacity per unit volume of the lithium ion secondary battery is small.

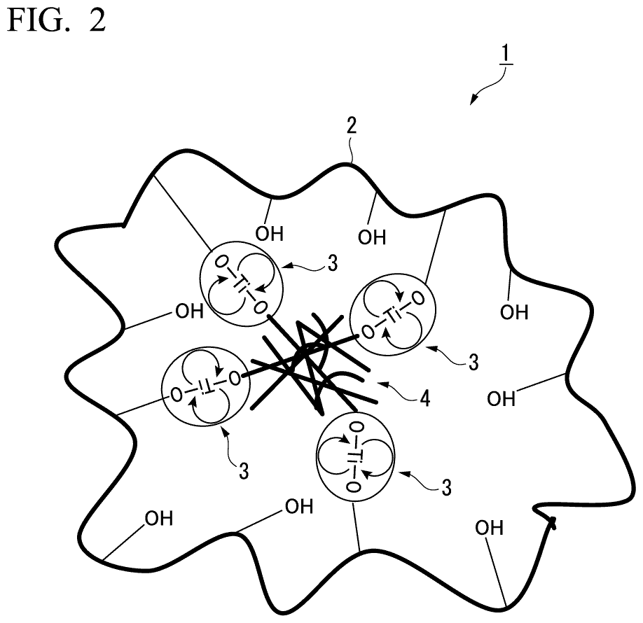

The binder binds the negative electrode active material together and binds the negative electrode active material to the negative electrode current collector. FIG. 2 is a schematic view of a binder 1 according to the first embodiment. The binder 1 contains a water-soluble polymer 2, a crosslinking agent 3 and cellulose nanofibers 4.

The water-soluble polymer 2 is, for example, a polymer having a hydroxyl group. The water-soluble polymer 2 is, for example, polyvinyl alcohol, carboxymethyl cellulose, methyl cellulose, a copolymer of acrylic acid and vinyl alcohol, a copolymer of sodium acrylate and vinyl alcohol, sodium carboxymethyl cellulose, polynorbornene dicarboxylic acid, or polyacrylic acid. The water-soluble polymer 2 is preferably polyvinyl alcohol, carboxymethyl cellulose, methyl cellulose, a copolymer of acrylic acid and vinyl alcohol, or polyacrylic acid. A copolymer of acrylic acid and vinyl alcohol can be obtained, for example, by copolymerizing a vinyl ester with an ethylenically unsaturated carboxylic acid ester, and hydrolyzing the copolymer by acidification. The water-soluble polymers 2 may be used alone or a plurality of types thereof may be used in combination.

The weight average molecular weight of the water-soluble polymer 2 is, for example, 9,000 or more and 200,000 or less. Particularly, when polyvinyl alcohol is used as the water-soluble polymer 2, the weight average molecular weight is preferably 9,000 or more and 200,000 or less. Since the water-soluble polymer 2 having a small molecular weight has few crosslinking points, the binder 1 cannot form a sufficient mesh structure, and the elasticity of the binder 1 decreases. If the molecular weight of the water-soluble polymer 2 is large, the binder 1 gels and is unlikely to be uniformly dispersed. When the water-soluble polymer 2 before crosslinking is available, the weight average molecular weight of the water-soluble polymer 2 is determined by analyzing the water-soluble polymer before crosslinking. When the water-soluble polymer 2 before crosslinking is not available, it can be estimated from the weight average molecular weight of the binder 1, and abundance proportions of the water-soluble polymer 2, the crosslinking agent 3 and the cellulose nanofibers 4 in the binder 1.

When polyvinyl alcohol is used as the water-soluble polymer 2, partially saponified polyvinyl alcohol or completely saponified polyvinyl alcohol prepared using saponified polyvinyl acetate is preferable. The polyvinyl alcohol is, for example, a vinyl alcohol-vinyl acetate copolymer, a vinyl alcohol-vinyl butyral copolymer, or an ethylene-vinyl alcohol copolymer, and preferably a vinyl alcohol-vinyl acetate copolymer.

The copolymerization proportion of polyvinyl alcohol is represented by the degree of saponification. The degree of saponification of polyvinyl alcohol is, for example, 60 mol % or more and 99 mol % or less. When the degree of saponification of polyvinyl alcohol is 60 mol % or more, it is easy to crosslink with the crosslinking agent 3. The degree of saponification of polyvinyl alcohol can be determined by the amount of alkali consumption required for hydrolysis of copolymer units such as vinyl acetate or composition analysis by NMR.

Here, whether the polymer is “water-soluble” can be determined by the following procedure. First, a mixture obtained by adding 1 part by weight of a polymer (corresponding to a solid content) with respect to 100 parts by weight of deionized water and performing stirring is prepared. The mixture is adjusted to one condition within the range of a temperature of 20 to 95° C. and a pH of 3 to 12 (pH adjustment is performed using a NaOH aqueous solution and/or an HCl aqueous solution). Next, the mixture is passed through a 250-mesh screen. When the weight of the solid content residue that does not pass through the screen and remains on the screen does not exceed 50 weight % of the solid content of the polymer added, the polymer can be said to be water-soluble. Here, even if a mixture of the polymer and water is in an emulsion state in which it separates into two phases when left to stand, the polymer is water-soluble if it satisfies the above definition.

The crosslinking agent 3 crosslinks between the water-soluble polymers 2 and between the water-soluble polymer 2 and the cellulose nanofibers 4.

The crosslinking agent 3 is, for example, a compound obtained by dissociating a blocking agent from any one selected from the group consisting of a blocked isocyanate silane compound, a blocked diisocyanate compound, and a blocked triisocyanate compound or a titanium compound. The crosslinking agent 3 shown in FIG. 2 is a titanium compound.

The titanium compound contains the titanium element in its structure. The titanium compound is an organic titanium compound, and is, for example, a titanium chelate. The titanium compound may be, for example, titanium lactate, titanium triethanol aminato, a titanium lactate ammonium salt, titanium diethanol aminato, titanium aminoethyl amino etherate or the like. The titanium compound is a crosslinking agent that connects the water-soluble polymer 2. The titanium compound is a compact crosslinking agent, and does not easily destroy the crystallinity of the water-soluble polymer 2.

In the blocked isocyanate silane compound, the blocked diisocyanate compound and the blocked triisocyanate compound, an active isocyanate group is protected with a blocking agent. The blocked isocyanate silane compound, the blocked diisocyanate compound and the blocked triisocyanate compound remain stable under normal conditions because the blocking agent protects the active isocyanate group, and the blocking agent dissociates according to a heat treatment. Examples of blocking agents include phenols, alcohols, oximes, and lactams.

Examples of diisocyanate compounds include aromatic diisocyanates having 6 to 20 carbon atoms (excluding carbon atoms in NCO groups, the same applies hereinafter), aliphatic diisocyanates having 2 to 18 carbon atoms, alicyclic diisocyanates having 4 to 15 carbon atoms, aromatic aliphatic diisocyanates having 8 to 15 carbon atoms, modified products of these diisocyanates (carbodiimide modified products, urethane modified products, uretdione modified products, etc.) and mixtures of two or more types thereof.

Examples of aromatic diisocyanates include 1,3- and/or 1,4-phenylene diisocyanate, 2,4- and/or 2,6-tolylene diisocyanate, m-xylylene diisocyanate, 2,4′- and/or 4,4′-diphenylmethane diisocyanate (hereinafter diphenylmethane diisocyanate will be abbreviated as MDI), 4,4′-diisocyanatobiphenyl, 3,3′-dimethyl-4,4′-diisocyanatobiphenyl, 3,3′-dimethyl-4,4′-diisocyanatodiphenylmethane, and 1,5-naphthylene diisocyanate.

Examples of aliphatic diisocyanates include ethylene diisocyanate, tetramethylene diisocyanate, hexamethylene diisocyanate, dodecamethylene diisocyanate, 2,2,4-trimethylhexamethylene diisocyanate, lysine diisocyanate, methyl 2,6-diisocyanatocaproate, bis(2-isocyanatoethyl)carbonate, and 2-isocyanatoethyl-2,6-diisocyanatohexanoate.

Examples of alicyclic diisocyanates include isophorone diisocyanate, dicyclohexylmethane-4,4′-diisocyanate, cyclohexylene diisocyanate, 1,3-bis(isocyanatomethyl)cyclohexane, methyl cyclohexylene diisocyanate, bis(2-isocyanatoethyl)-4-cyclohexylene-1,2-dicarboxylate, and 2,5- and/or 2,6-norbornane diisocyanate.

Examples of aromatic aliphatic diisocyanates include m- and/or p-xylylene diisocyanate, and α,α,α′,α′-tetramethylene xylylene diisocyanate.

The triisocyanate compound has, for example, three isocyanate groups.

For example, the following Chemical Formulae (1-1) to (1-7) are examples of triisocyanates.

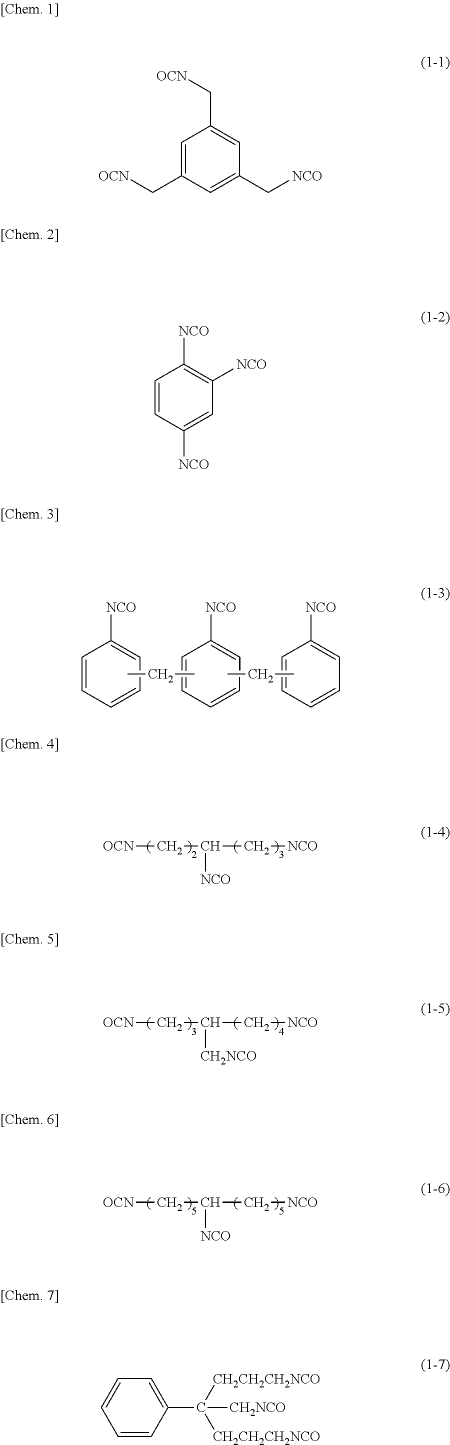

In addition, the triisocyanate may also be a compound having a biuret structure represented by the following Chemical Formula (1-8). The compound having a biuret structure represented by Chemical Formula (1-8) is formed from urea and an isocyanate group. In Formula (1-8), R is a group obtained by removing one isocyanate group from a diisocyanate monomer.

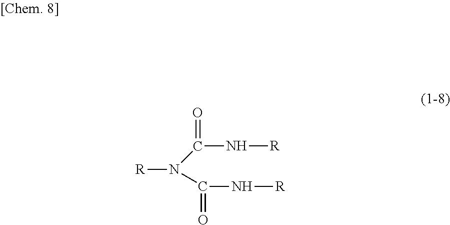

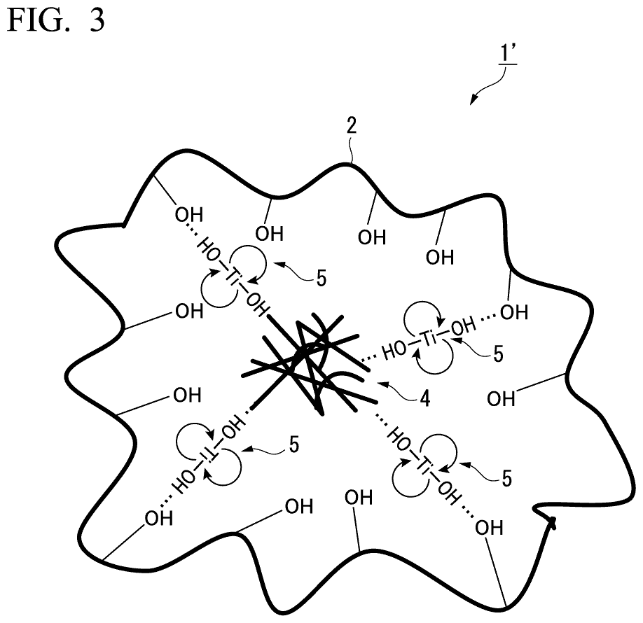

FIG. 3 is a schematic view of the binder according to the first embodiment before crosslinking. A binder 1′ before crosslinking contains the water-soluble polymer 2, a crosslinking precursor 5 and the cellulose nanofibers 4. The crosslinking precursor 5 is a crosslinking agent before crosslinking.

The crosslinking precursor 5 shown in FIG. 3 is a titanium compound. The crosslinking precursor 5 may be any one selected from the group consisting of a blocked isocyanate silane compound, a blocked diisocyanate compound, and a blocked triisocyanate compound.

As shown in FIG. 3, when the crosslinking precursor 5 is a titanium compound, the hydroxyl group of the water-soluble polymer 2 reacts with the hydroxyl group of the titanium compound, the water-soluble polymer 2 and the crosslinking agent 3 are crosslinked. In addition, when the hydroxyl group attached to the surface of the cellulose nanofibers 4 reacts with the hydroxyl group of the titanium compound, the cellulose nanofibers 4 and the crosslinking agent 3 are crosslinked. The crosslinking reaction is not limited to the reaction between hydroxyl groups. For example, an alkoxy group of the titanium compound may be desorbed and react with the hydroxyl group of the water-soluble polymer 2 or the cellulose nanofibers 4. In addition, an isocyanate group, a carboxy group and the like of the titanium compound may react with the hydroxyl group of the water-soluble polymer 2 or the cellulose nanofibers 4.

In addition, when the crosslinking precursor 5 is any one selected from the group consisting of a blocked isocyanate silane compound, a blocked diisocyanate compound, and a blocked triisocyanate compound, the hydroxyl group of the water-soluble polymer 2 reacts with an active isocyanate group, and thus the water-soluble polymer 2 and the crosslinking agent 3 are crosslinked. In addition, when the hydroxyl group attached to the surface of the cellulose nanofibers 4 reacts with the active isocyanate group, the cellulose nanofibers 4 and the crosslinking agent 3 are crosslinked.

Some hydroxyl groups of the water-soluble polymer 2 remain unreacted without reacting with the crosslinking precursor 5. The remaining hydroxyl groups interact with the hydroxyl groups attached to the surface of the negative electrode active material, and the negative electrode active material and the binder 1 are bound together.

For example, the abundance proportion of the crosslinking agent 3 in the binder 1 with respect to 100 parts by weight of the water-soluble polymer 2 is 5 parts by weight or more and less than 53 parts by weight. In addition, for example, the abundance proportion of the crosslinking agent 3 in the binder 1 with respect to 100 parts by weight of the water-soluble polymer 2 is preferably 13 parts by weight or more and less than 28 parts by weight. When the abundance proportion of the crosslinking agent 3 is low, there are few crosslinking points in the binder 1, and the elasticity of the binder decreases. The binder 1 with low elasticity cannot sufficiently reduce the volume change during charging and discharging. The negative electrode active material layer 34 containing the binder 1 with low elasticity tends to crack during charging and discharging. In addition, when the abundance proportion of the crosslinking agent 3 is high, the proportion of hydroxyl groups that can be present freely in the binder 1 decreases, and the binding strength between the negative electrode active material and the negative electrode current collector 32 decreases. In addition, since the binder 1 having a high abundance proportion of the crosslinking agent 3 has low dispersibility in water, it has a high viscosity and may gel.

The cellulose nanofibers 4 are made of finely untangled cellulose, the main component of plant fibers, to nano size. The cellulose nanofibers 4 bind to the water-soluble polymer 2 via the crosslinking agent 3 and bind to the negative electrode active material.

The average fiber length of the cellulose nanofibers 4 is, for example, 0.1 μm or more and 1,000 μm or less, preferably 1 μm or more and 750 μm or less, more preferably 1.3 μm or more and 500 μm or less, still more preferably 1.4 μm or more and 250 μm or less, and particularly preferably 2.0 μm or more and 100 μm or less. When the fiber length of the cellulose nanofibers 4 is long, the flatness of the coating film decreases when applied. When the fiber length of the cellulose nanofibers 4 is short, the adhesion to the negative electrode active material decreases.

The average fiber diameter of the cellulose nanofibers 4 is, for example, 1 nm or more and 10 μm or less, preferably 5 nm or more and 2.5 μm or less, more preferably 20 nm or more and 700 nm or less, and still more preferably 30 nm or more and 200 nm or less.

The abundance proportion of the cellulose nanofibers 4 in the binder 1, for example, with respect to a total amount of 100 of the water-soluble polymer 2 and the cellulose nanofibers 4 in terms of solid content, is preferably 2% or more and 10% or less. When the abundance proportion of the cellulose nanofibers 4 is low, the strength of the binder 1 decreases. When the abundance proportion of the cellulose nanofibers 4 is high, the dispersibility of the binder 1 in water decreases, the viscosity of the binder 1 increases, and the binder 1 may gel.

The binder 1 according to the present embodiment has a peak at a diffraction angle 2θ in a range of 16° or more and 21° or less when measured by wide-angle X-ray scattering (WAXS) using CuKα rays. In addition, the half-value width (full width at half maximum: FWHM) of the peak is 5.5° or less.

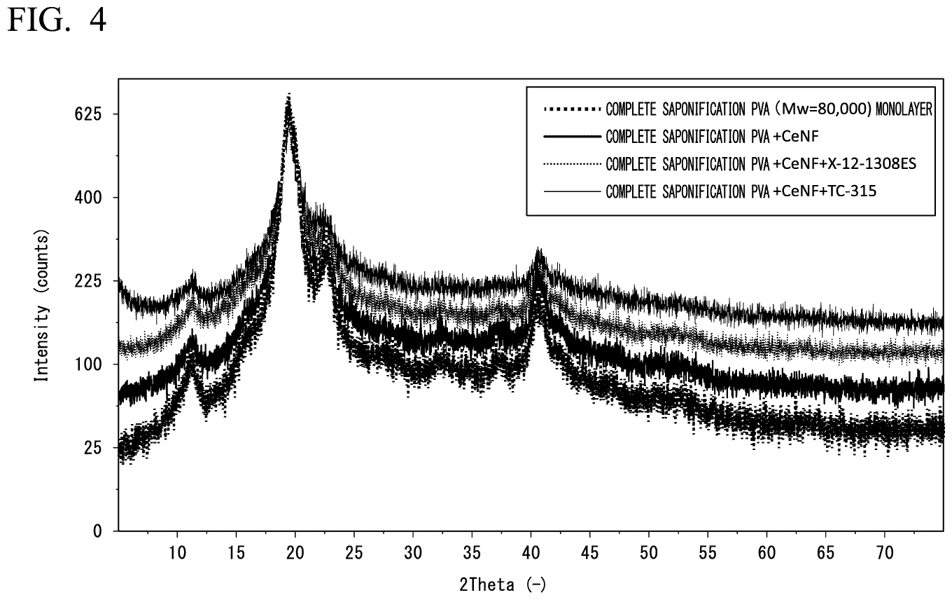

FIG. 4 is an example of wide-angle X-ray scattering (WAXS) measurement results of the binder and the like according to the first embodiment. Wide-angle X-ray scattering is performed using CuKα rays. FIG. 4 shows the measurement results of four substances.

The first substance is a completely saponified polyvinyl alcohol (PVA) with a molecular weight of 80,000, and is a single film of the above water-soluble polymer 2. The second substance is obtained by mixing a completely saponified polyvinyl alcohol (PVA) with a molecular weight of 80,000 with the cellulose nanofibers 4 and performing heating. The third substance is a first example of the binder 1 according to the present embodiment. The binder 1 of the first example is a crosslinked product of the water-soluble polymer 2 composed of a completely saponified polyvinyl alcohol (PVA) with a molecular weight of 80,000, the crosslinking precursor 5 composed of a blocked isocyanate (X-12-1308ES, commercially available from Shin-Etsu Chemical Co., Ltd.), and the cellulose nanofibers 4. The fourth substance is a second example of the binder 1 according to the present embodiment. The binder 1 of the second example is a crosslinked product of the water-soluble polymer 2 composed of a completely saponified polyvinyl alcohol (PVA) with a molecular weight of 80,000, the crosslinking precursor 5 composed of titanium lactate (Orgatix TC-315 (commercially available from Matsumoto Fine Chemical Co., Ltd.)), and the cellulose nanofibers 4.

The first substance to the third substance have a peak at a diffraction angle 2θ of 19.4°, and the fourth substance has a peak at a diffraction angle 2θ of 19.5°. That is, the first substance to the fourth substance all have a peak at a diffraction angle 2θ in a range of 16° or more and 21° or less. This peak is a peak derived from the water-soluble polymer 2. The fact that the peak is also observed for the third substance and the fourth substance indicates that the water-soluble polymer 2 is present in the binder 1.

In addition, the half-value width of the peak is 1.5° in the first substance to the third substance, and the half-value width of the peak is 1.9° in the fourth substance. That is, in all of the first substance to the fourth substance, the half-value width of the peak is 5.5° or less. A narrow half-value width of the peak indicates high crystallinity of the binder 1. The fact that the half-value width of the peak is 5.5° or less in the third substance and the fourth substance indicates that the water-soluble polymer 2 that maintains its crystallinity is present in the binder 1. The position and half-value width of the peak of the binder 1 can be controlled by controlling the proportion of the water-soluble polymer in the binder, binder curing conditions and the like.

The content of the binder in the negative electrode active material layer 34 is not particularly limited. For example, the content of the binder with respect to a total mass of the negative electrode active material, the conductive assistant, and the binder is 0.5 mass % or more and 20 mass % or less, and preferably 5 mass % or more and 15 mass % or less. If the content of the binder is low, the adhesive strength of the negative electrode 30 is weakened. If the content of the binder is large, since the binder is electrochemically inactive and does not contribute to the discharging capacity, the energy density of the lithium ion secondary battery 100 decreases.

The conductive assistant in the negative electrode active material layer 34 increases the electron conductivity within the negative electrode active material. As the conductive assistant, the same one as the positive electrode active material layer 24 can be used.

The content of the conductive assistant in the negative electrode active material layer 34 is not particularly limited. For example, the content of the conductive assistant with respect to a total mass of the negative electrode active material, the conductive assistant, and the binder is 5 mass % or more and 20 mass % or less and preferably 1 mass % or more and 12 mass % or less.

### <Separator>

The separator 10 is inserted between the positive electrode 20 and the negative electrode 30. The separator 10 separates the positive electrode 20 from the negative electrode 30, and prevents short-circuiting between the positive electrode 20 and the negative electrode 30. The separator 10 extends in-plane along the positive electrode 20 and the negative electrode 30. Lithium ions can pass through the separator 10.

The separator 10 has, for example, an electrically insulating porous structure. The separator 10 is, for example, a single-layer component or laminate of a polyolefin film. The separator 10 may be a stretched film of a mixture of polyethylene, polypropylene and the like. The separator 10 may be a fiber nonwoven fabric made of at least one constituent material selected from the group consisting of cellulose, polyester, polyacrylonitrile, polyamide, polyethylene and polypropylene. The separator 10 may be, for example, a solid electrolyte. Examples of solid electrolytes include a polymer solid electrolyte, an oxide-based solid electrolyte, and a sulfide-based solid electrolyte. The separator 10 may be an inorganic-coated separator. The inorganic-coated separator is formed by applying a mixture of a resin such as PVDF or CMC and an inorganic substance such as alumina or silica to the surface of the film. The inorganic-coated separator has excellent heat resistance and prevents a transition metal eluted from the positive electrode from precipitating on the surface of the negative electrode.

### <Electrolytic Solution>

The electrolytic solution is enclosed in the exterior body 50, and impregnated into the power generating element 40. The non-aqueous electrolytic solution contains, for example, a non-aqueous solvent and an electrolyte salt. The electrolyte salt is dissolved in the non-aqueous solvent.

As the electrolytic solution, a known electrolytic solution can be used. The electrolytic solution contains, for example, a non-aqueous solvent and an electrolyte salt.

The electrolyte salt is, for example, a lithium salt. Examples of electrolytes include LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, and LiN(FSO₂)₂. The lithium salts may be used alone or two or more thereof may be used in combination. In consideration of the degree of ionization, the electrolyte preferably contains LiPF₆. The concentration of the electrolyte salt is, for example, 0.8 mol/L or more and 5.0 mol/L or less.

The non-aqueous solvent is, for example, an aprotic organic solvent. Examples of organic solvents include a cyclic carbonate, a chain carbonate, an ether, and mixtures thereof. In addition, the solvent may be an ionic liquid.

The cyclic carbonate solvates an electrolyte. Examples of cyclic carbonates include ethylene carbonate, propylene carbonate, butylene carbonate, and fluoroethylene carbonate. The cyclic carbonate preferably contains at least fluoroethylene carbonate. Fluoroethylene carbonate (FEC) has a high oxidation-reduction potential and is easily reduced and decomposed. When fluoroethylene carbonate (FEC) is partially reduced and decomposed, the electrolyte and remaining solvent in the electrolytic solution are less likely to decompose. In addition, fluoroethylene carbonate (FEC) forms a thin and stable coating (SEI coating) on the entire surface of the negative electrode active material when the lithium ion secondary battery is initially used. The SEI coating prevents direct contact between the negative electrode active material and the electrolytic solution, and prevents the electrolytic solution from decomposing.

Chain carbonates reduce the viscosity of cyclic carbonates. Examples of chain carbonates include diethyl carbonate, dimethyl carbonate, and ethyl methyl carbonate. The non-aqueous solvent may also contain methyl acetate, ethyl acetate, methyl propionate, ethyl propionate, propyl propionate, γ-butyrolactone, 1,2-dimethoxyethane, 1,2-diethoxyethane and the like.

In addition, the electrolytic solution may also contain a solid electrolyte interface (SEI) forming material, a surfactant and the like. Examples of additives include vinylene carbonate, vinyl ethylene carbonate, phenyl ethylene carbonate, succinic anhydride, lithium bisoxalate, lithium tetrafluoroborate, dinitro compounds, propane sultone, butane sultone, propene sultone, 3-sulfolene, fluorinated allyl ether, and fluorinated acrylate.

### <Exterior Body>

The exterior body 50 seals the power generating element 40 and the non-aqueous electrolytic solution therein. The exterior body 50 prevents the non-aqueous electrolytic solution from leaking to the outside and prevents water and the like from entering the lithium ion secondary battery 100 from the outside.

For example, as shown in FIG. 1, the exterior body 50 includes a metal foil 52, and resin layers 54 laminated on sides of the metal foil 52. The exterior body 50 is a metal laminate film in which both sides of the metal foil 52 are coated with a polymer film (the resin layer 54).

As the metal foil 52, for example, an aluminum foil can be used. As the resin layer 54, a polymer film such as polypropylene can be used. The material constituting the resin layer 54 may be different between the inside and the outside. For example, as the outer material, a polymer with a high melting point, for example, polyethylene terephthalate (PET), polyamide (PA) or the like can be used, and as the material for the inner polymer film, polyethylene (PE), polypropylene (PP) or the like can be used.

### <Terminal>

The terminals 60 and 62 are connected to the negative electrode 30 and the positive electrode 20, respectively. The terminal 62 connected to the positive electrode 20 is a positive electrode terminal, and the terminal 60 connected to the negative electrode 30 is a negative electrode terminal. The terminals 60 and 62 are responsible for electrical connection between the outside and the power generating element 40. The terminals 60 and 62 are formed of a conductive material such as aluminum, nickel, or copper. The connection method may be performed by welding or screwing. In order to prevent short-circuiting, it is preferable that the terminals 60 and 62 be protected with an insulating tape.

### “Method of Producing Lithium Ion Secondary Battery”

The negative electrode 30, the positive electrode 20, the separator 10, the electrolytic solution, and the exterior body 50 are prepared, and the lithium ion secondary battery 100 is prepared by assembling them. Hereinafter, an example of a method of producing the lithium ion secondary battery 100 will be described.

First, the negative electrode 30 is prepared. The negative electrode 30 is prepared by performing, for example, a precursor solution preparing step, a slurry preparing step, an electrode coating step, a curing step, and a rolling step in this order.

First, the precursor solution preparing step is performed. Initially, a water-soluble polymer solution, the crosslinking precursor 5 and the cellulose nanofibers 4 are arranged. The crosslinking precursor 5 is a crosslinking agent before crosslinking. The crosslinking precursor 5 is a titanium compound, a blocked isocyanate silane compound, a blocked diisocyanate compound, or a blocked triisocyanate compound. Next, the water-soluble polymer solution, the crosslinking precursor 5, and the cellulose nanofibers 4 are mixed to prepare a binder precursor solution. The mixing ratio of the water-soluble polymer solution, the crosslinking precursor 5 and the cellulose nanofibers 4 is adjusted according to the composition of a desired binder.

Although it depends on the type of the water-soluble polymer, when the water-soluble polymer is dissolved in water, stirring is performed for 2 hours or longer at room temperature to 100° C. or lower. The rotational speed during stirring is set to 550 rpm or more and 1,500 rpm or less to completely dissolve the water-soluble polymer. Then, the crosslinking precursor 5 and the cellulose nanofibers 4 are added to the water-soluble polymer solution, and the mixture is stirred at room temperature for 5 minutes or longer. The rotational speed during stirring is, for example, 180 rpm or more and 400 rpm or less. When the crosslinking precursor 5 and the cellulose nanofibers 4 are sufficiently dispersed in the water-soluble polymer solution, it is possible to increase the crystallinity of the cured binder.

Next, the slurry preparing step is performed. In the slurry preparing step, a negative electrode active material (silicon or silicon compound) and a conductive assistant are added to a binder precursor solution.

Examples of solvents include water and N-methyl-2-pyrrolidone. The composition ratio (mass ratio) of the negative electrode active material, the conductive assistant, and the binder precursor solution is, for example, 70 wt % to 100 wt %:0 wt % to 10 wt %:0 wt % to 20 wt %. These mass ratios are adjusted so that a total amount is 100 wt %.

The negative electrode active material may be a composite obtained by mixing active material particles and a conductive material while applying a shear force. When the active material particles are mixed with a shear force applied to the extent that the particles do not deteriorate, the surfaces of the active material particles are covered with the conductive material. In addition, the particle size of the negative electrode active material can be adjusted according to the degree of mixing. In addition, the prepared negative electrode active material may be sieved to make the particle size uniform.

Next, the electrode coating step is performed. The electrode coating step is a step of applying a slurry to the surface of the negative electrode current collector 32. The slurry application method is not particularly limited. For example, a slit die coating method or a doctor blade method can be used as the slurry application method.

Next, the curing step is performed. In the curing step, the slurry is annealed. When the slurry is annealed, the water-soluble polymer 2, the crosslinking agent 3 and the cellulose nanofibers 4 are crosslinked. In addition, in the curing step, the solvent is removed. The curing step is performed, for example, in a nitrogen atmosphere. The curing temperature is, for example, 120° C. or higher and 150° C. or lower. In addition, the rate of temperature rise up to the curing temperature is, for example, 2° C./min or more and 5° C./min or less. In addition, the temperature drop rate after curing is, for example, 2° C./min or more and 5° C./min or less. As described above, the position and half-value width of the peak in the wide-angle X-ray scattering (WAXS) measurement results of the cured binder can be controlled by sufficiently dispersing the crosslinking precursor 5 and the cellulose nanofibers 4 in the water-soluble polymer solution in the precursor solution preparing step, adjusting the mixing ratio of the water-soluble polymer 2, the crosslinking precursor 5 and the cellulose nanofibers 4 in the binder, and curing the binder under the above conditions.

The rolling step is performed as necessary. The rolling step is a step of applying a pressure to the negative electrode active material layer 34 to adjust the density of the negative electrode active material layer 34. The rolling step is performed using, for example, a roll press device.

The positive electrode 20 can be prepared in the same procedure as in the negative electrode 30. As the separator 10 and the exterior body 50, commercially available products can be used.

Next, the power generating element 40 is prepared by laminating the prepared positive electrode 20 and negative electrode 30 so that the separator 10 is positioned therebetween. When the power generating element 40 is a wound body, the positive electrode 20, the negative electrode 30 and the separator 10 are wound around one end side as an axis.

Finally, the power generating element 40 is enclosed in the exterior body 50. The non-aqueous electrolytic solution is injected into the exterior body 50. When the pressure is reduced, heating or the like is performed after the non-aqueous electrolytic solution is injected, the non-aqueous electrolytic solution is impregnated into the power generating element 40. When the exterior body 50 is sealed by applying heat or the like, the lithium ion secondary battery 100 is obtained. Here, instead of injecting the electrolytic solution into the exterior body 50, the power generating element 40 may be impregnated into the electrolytic solution.

The lithium ion secondary battery 100 according to the first embodiment has excellent cycle characteristics. This is thought to be because the binder contained in the negative electrode active material layer 34 has high strength and high elasticity. When the water-soluble polymer maintains its crystallinity, the binder has high strength and high elasticity. This can be confirmed by the fact that the binder 1 has a predetermined peak in the wide-angle X-ray scattering (WAXS) measurement results. The crosslinking agent 3 is preferentially adsorbed to the cellulose nanofibers 4. Therefore, it is thought that an excessive reaction between the crosslinking agent 3 and the water-soluble polymer 2 is inhibited, and the water-soluble polymer 2 with high crystallinity is maintained within the binder 1. In addition, when the crosslinking agent 3 having a compact crystal structure crosslinks the water-soluble polymer, the binder 1 has high strength and high elasticity.

The embodiments of the present invention have been described in detail above with reference to the drawings, and configurations and combinations thereof in the embodiments are only examples, and additions, omissions, substitutions and other modifications of the configurations can be made without departing from the spirit and scope of the present invention.

### EXAMPLES

### Example 1

First, a binder precursor solution was prepared. First, 100 parts by mass of a water-soluble polymer and water were added, and the mixture was stirred at room temperature for 2 hours or longer. The rotational speed during stirring was set to 550 rpm or more and 1,500 rpm or less. Then, the mixture was stirred until the water-soluble polymer was completely dissolved in water. Then, 3 parts by mass of a crosslinking precursor and 10 parts by mass of cellulose nanofiber were added to the water-soluble polymer aqueous solution. The solution was stirred at room temperature and a rotational speed of 300 rpm for 5 minutes or longer. Carboxymethyl cellulose with a molecular weight of 90,000 was used as the water-soluble polymer. Titanium lactate (Orgatix TC-315 (commercially available from Matsumoto Fine Chemical Co., Ltd.)) was used as the crosslinking precursor. Rheocrysta I-2SX standard grade (commercially available from DKS Co., Ltd.) was used as the cellulose nanofibers.

Next, a negative electrode active material and a conductive assistant were added to the binder precursor solution. The negative electrode active material was SiOₓ, which had been subjected to a disproportionation reaction by a heat treatment at 1,000° C. under a reduced pressure. The conductive assistant was Super-P (registered trademark). Then, 25 g of the negative electrode active material, 1.4 g of the conductive assistant, and 13.5 g of the binder precursor solution (with a solid content concentration of 10%) were mixed to prepare a coating liquid (slurry). The total solid content concentration in the coating liquid was 35 wt %. Next, the slurry was applied onto a copper foil serving as a negative electrode current collector with a doctor blade.

Next, the negative electrode current collector coated with the slurry was annealed in a nitrogen atmosphere. The annealing was performed under the conditions of increasing the temperature at 5° C./min, keeping it at 150° C. for 2 hours, and decreasing the temperature at 5° C./min. By the annealing, the water-soluble polymer, the crosslinking agent and the cellulose nanofibers were crosslinked, and the slurry was cured. Then, the negative electrode current collector after the slurry was cured was rolled to form the negative electrode active material layer 34. A mold was used to punch out the negative electrode current collector and the negative electrode active material layer 34 into an electrode size of 22×32 mm to prepare a negative electrode.

Here, a binder precursor solution was prepared under the same conditions as above, and the binder precursor solution was annealed to prepare a binder (not including a negative electrode active material or a conductive assistant). This binder was subjected to wide-angle X-ray scattering measurement using CuKα rays. In the binder of Example 1, the diffraction angle 2θ was 16.2°, and the half-value width was 3.3°.

LiₓCoO₂ was used as the positive electrode active material. Ketjen black was used as the conductive assistant. Polyvinylidene fluoride (PVDF) was used as the binder. N-methyl-2-pyrrolidone was used as the solvent. 96 parts by mass of the positive electrode active material, 2 parts by mass of the conductive assistant, 2 parts by mass of the binder, and 70 parts by mass of the solvent were mixed to prepare a positive electrode slurry. Then, the positive electrode slurry was applied to one surface of an aluminum foil with a thickness of 15 μm, vacuum-dried at 100° C. for 2 hours, and rolled to form the positive electrode active material layer 24. Then, a mold was used to punch out the positive electrode current collector and the positive electrode active material layer 24 into an electrode size of 22×32 mm to prepare a positive electrode.

Next, an electrolytic solution was prepared. A mixture containing ethylene carbonate (EC) and diethyl carbonate (DEC) at a mass ratio of 3:7 was used as the solvent. LiPF₆ was used as an electrolyte salt. The concentration of LiPF₆ was 1 mol/L.

### (Preparation of Lithium Ion Secondary Battery for Evaluation)

A laminate was obtained by laminating the prepared negative electrode and positive electrode with a separator (porous polyethylene sheet) therebetween so that the positive electrode active material layer and the negative electrode active material layer faced each other. A negative electrode lead made of nickel was attached to the negative electrode of the laminate. A positive electrode lead made of aluminum was attached to the positive electrode of the laminate. The positive electrode lead and the negative electrode lead were welded by an ultrasonic welding machine. This laminate was inserted into the exterior body formed of an aluminum laminate film and heat-sealed except for one peripheral part to form a closed part. Then, finally, after the electrolytic solution was injected into the exterior body, one remaining part was sealed by heat sealing while reducing the pressure with a vacuum sealing machine to prepare a lithium ion secondary battery.

(Measurement of Capacity Retention Rate after 200 Cycles)

Cycle characteristics of the lithium ion secondary battery were measured. Cycle characteristics were measured using a secondary battery charging and discharging test device (commercially available from Hokuto Denko Corporation).

The battery was charged according to constant current charging at a charging rate of 0.5C (a current value at which charging was completed in 1 hour when constant current charging was performed at 25° C.) until the battery voltage reached 4.2 V, and discharged according to constant current discharging at a discharging rate of 1.0C until the battery voltage reached 2.5 V. The discharging capacity after charging and discharging were completed was detected to determine a battery capacity Q₁ before the cycle test.

Using the secondary battery charging and discharging test device, the battery whose battery capacity Q₁ was determined above was again charged according to constant current charging at a charging rate of 0.5C until the battery voltage reached 4.2 V. and discharged according to constant current discharging at a discharging rate of 1.0C until the battery voltage reached 2.5 V. The above charging and discharging were counted as one cycle, and 200 charging and discharging cycles were performed. Then, the discharging capacity after 200 charging and discharging cycles were completed was detected to determine a battery capacity Q₂ after 200 cycles.

A capacity retention rate E after 200 cycles was determined from the capacities Q₁ and Q₂ determined above. The capacity retention rate E was determined by E=Q₂/Q₁×100. The capacity retention rate of Example 1 was 66%.

### Examples 2 to 66

Examples 2 to 66 differed from Example 1 in that any one of the type of the water-soluble polymer, the type of the crosslinking precursor, the mass ratio of the crosslinking precursor to the water-soluble polymer, and the mass ratio of the cellulose nanofibers to the water-soluble polymer was changed. In addition, Examples 2 to 66 differed from Example 1 in that, when polyvinyl alcohol was used as the water-soluble polymer, it was dissolved at 100° C. to obtain a polyvinyl alcohol aqueous solution. The other conditions were the same as in Example 1, and the peak position and the half-value width of the binder, and the capacity retention rate were determined.

### Comparative Example 1

Comparative Example 1 differed from Example 1 in that, when the binder was prepared, the crosslinking precursor and the cellulose nanofibers were not added. The other conditions were the same as in Example 1, and the peak position and the half-value width of the binder, and the capacity retention rate were determined.

### Comparative Example 2

Comparative Example 2 differed from Example 1 in that, when the binder was prepared, the crosslinking precursor was not added. The other conditions were the same as in Example 1, and the peak position and the half-value width of the binder, and the capacity retention rate were determined.

### Comparative Example 3

Comparative Example 3 differed from Example 1 in that, when the binder was prepared, the mass ratio of the crosslinking precursor to the water-soluble polymer and the mass ratio of the cellulose nanofibers to the water-soluble polymer were changed. The other conditions were the same as in Example 1, and the peak position and the half-value width of the binder, and the capacity retention rate were determined.

### Examples 67 to 72

Examples 67 to 72 differed from Example 1 in that polyacrylic acid was used as the water-soluble polymer, and any one of the type of the crosslinking precursor, the mass ratio of the crosslinking precursor to the water-soluble polymer, and the mass ratio of the cellulose nanofibers to the water-soluble polymer was changed. The other conditions were the same as in Example 1, and the peak position and the half-value width of the binder, and the capacity retention rate were determined.

The results of Examples 1 to 72 and Comparative Examples 1 to 3 are summarized in Table 1 to Table 5. TC-300 in the table is Orgatix TC-300 (commercially available from Matsumoto Fine Chemical Co., Ltd.). TC-300 is a titanium lactate ammonium salt. Similarly, TC-315 in the table is Orgatix TC-315 (commercially available from Matsumoto Fine Chemical Co., Ltd.). TC-315 is titanium lactate. In addition, Mw in the table is the weight average molecular weight of the water-soluble polymer. In addition, X-12-1308ES in the table is a blocked isocyanate (commercially available from Shin-Etsu Chemical Co., Ltd.). In addition, blocked 4,4-diphenylmethane diisocyanate is a blocked diisocyanate. In addition, 1,3,5-tris(isocyanatomethyl)benzene and 1,3,5-tris(6-isocyanatohexyl)biuret are blocked triisocyanates.

TABLE 1

| | | | | | | | Measurement results | | |
|---|---|---|---|---|---|---|---|---|---|
| | | | | Proportions | | | | Half- | Capacity |
| | Water-soluble polymer | | | Water- | | | Diffraction | value | retention |
| | Substance | | | soluble | Crosslinking | Cellulose | angle 2θ | width | rate |
| | name | Mw | Crosslinking precursor | polymer | precursor | nanofiber | (°) | (°) | (%) |
| Exam- | carboxymethyl | 90000 | TC-315 | 100 | 3 | 10 | 16.2 | 3.3 | 66 |
| ple 1 | cellulose | | | | | | | | |
| Exam- | methyl | 140000 | TC-315 | 100 | 3 | 10 | 17.8 | 3.4 | 66 |
| ple 2 | cellulose | | | | | | | | |
| Exam- | poly(acrylic | 60000 | TC-315 | 100 | 3 | 10 | 18.3 | 3.5 | 68 |
| ple 3 | acid + vinyl | | | | | | | | |
| | alcohol) | | | | | | | | |
| Exam- | carboxymethyl | 90000 | TC-300 | 100 | 13 | 5 | 16.5 | 4.0 | 67 |
| ple 4 | cellulose | | | | | | | | |
| Exam- | methyl | 140000 | TC-300 | 100 | 50 | 2 | 17.9 | 5.3 | 62 |
| ple 5 | cellulose | | | | | | | | |
| Exam- | poly(acrylic | 60000 | TC-315 | 100 | 26 | 2 | 18.8 | 4.3 | 66 |
| ple 6 | acid + vinyl | | | | | | | | |
| | alcohol) | | | | | | | | |
| Exam- | carboxymethyl | 90000 | X-12-1308ES | 100 | 3 | 10 | 16.3 | 3.1 | 65 |
| ple 7 | cellulose | | | | | | | | |
| Exam- | methyl | 140000 | X-12-1308ES | 100 | 3 | 10 | 17.6 | 3.3 | 64 |
| ple 8 | cellulose | | | | | | | | |
| Exam- | poly(acrylic | 60000 | X-12-1308ES | 100 | 3 | 10 | 18.5 | 3.4 | 67 |
| ple 9 | acid + vinyl | | | | | | | | |
| | alcohol) | | | | | | | | |
| Exam- | carboxymethyl | 90000 | blocked 4,4-diphenylmethane | 100 | 5 | 10 | 16.4 | 3.5 | 64 |
| ple 10 | cellulose | | diisocyanate (MDI) | | | | | | |
| Exam- | methyl | 140000 | blocked 4,4-diphenylmethane | 100 | 13 | 10 | 18.0 | 4.2 | 63 |
| ple 11 | cellulose | | diisocyanate (MDI) | | | | | | |
| Exam- | poly(acrylic | 60000 | blocked 4,4-diphenylmethane | 100 | 26 | 2 | 18.5 | 4.5 | 64 |
| ple 12 | acid + vinyl | | diisocyanate (MDI) | | | | | | |
| | alcohol) | | | | | | | | |
| Exam- | carboxymethyl | 90000 | blocked 1,3,5- | 100 | 3 | 10 | 16.4 | 3.6 | 64 |
| ple 13 | cellulose | | tris(isocyanatomethyl)benzene | | | | | | |
| Exam- | methyl | 140000 | blocked 1,3,5- | 100 | 13 | 5 | 17.7 | 4.4 | 65 |
| ple 14 | cellulose | | tris(isocyanatomethyl)benzene | | | | | | |
| Exam- | poly(acrylic | 60000 | blocked 1,3,5- | 100 | 52 | 2 | 18.6 | 5.5 | 64 |
| ple 15 | acid + vinyl | | tris(isocyanatomethyl)benzene | | | | | | |
| | alcohol) | | | | | | | | |
| Exam- | methyl | 140000 | blocked 1,3,5-tris(6- | 100 | 12 | 2 | 17.5 | 4.5 | 65 |
| ple 16 | cellulose | | isocyanatohexyl)biuret | | | | | | |
| Exam- | poly(acrylic | 60000 | blocked 1,3,5-tris(6- | 100 | 24 | 2 | 18.4 | 5.2 | 66 |
| ple 17 | acid + vinyl | | isocyanatohexyl)biuret | | | | | | |
| | alcohol) | | | | | | | | |

TABLE 2

| | | | | | | | Measurement results | | |
|---|---|---|---|---|---|---|---|---|---|
| | | | | Proportions | | | | Half- | Capacity |
| | Water-soluble polymer | | | Water- | | | Diffraction | value | retention |
| | Substance | | Crosslinking | soluble | Crosslinking | Cellulose | angle 2θ | width | rate |
| | name | Mw | precursor | polymer | precursor | nanofiber | (°) | (°) | (%) |
| Exam- | partially | 30000 | TC-315 | 100 | 5 | 10 | 19.3 | 3.3 | 79 |
| ple 18 | saponified | | | | | | | | |
| | polyvinyl | | | | | | | | |
| | alcohol | | | | | | | | |
| Exam- | partially | 30000 | TC-315 | 100 | 13 | 5 | 19.5 | 4.2 | 78 |
| ple 19 | saponified | | | | | | | | |
| | polyvinyl | | | | | | | | |
| | alcohol | | | | | | | | |
| Exam- | partially | 30000 | TC-315 | 100 | 26 | 2 | 19.8 | 5.0 | 76 |
| ple 20 | saponified | | | | | | | | |
| | polyvinyl | | | | | | | | |
| | alcohol | | | | | | | | |
| Exam- | partially | 30000 | TC-315 | 100 | 52 | 2 | 20.0 | 5.5 | 74 |
| ple 21 | saponified | | | | | | | | |
| | polyvinyl | | | | | | | | |
| | alcohol | | | | | | | | |
| Exam- | partially | 70000 | TC-315 | 100 | 5 | 5 | 19.3 | 3.5 | 82 |
| ple 22 | saponified | | | | | | | | |
| | polyvinyl | | | | | | | | |
| | alcohol | | | | | | | | |
| Exam- | partially | 70000 | TC-315 | 100 | 13 | 2 | 19.4 | 4.2 | 80 |
| ple 23 | saponified | | | | | | | | |
| | polyvinyl | | | | | | | | |
| | alcohol | | | | | | | | |
| Exam- | partially | 70000 | TC-315 | 100 | 26 | 2 | 19.6 | 5.3 | 79 |
| ple 24 | saponified | | | | | | | | |
| | polyvinyl | | | | | | | | |
| | alcohol | | | | | | | | |
| Exam- | partially | 160000 | TC-315 | 100 | 13 | 2 | 19.6 | 4.4 | 79 |
| ple 25 | saponified | | | | | | | | |
| | polyvinyl | | | | | | | | |
| | alcohol | | | | | | | | |
| Exam- | partially | 160000 | TC-315 | 100 | 26 | 2 | 19.9 | 5.4 | 75 |
| ple 26 | saponified | | | | | | | | |
| | polyvinyl | | | | | | | | |
| | alcohol | | | | | | | | |
| Exam- | completely | 80000 | TC-315 | 100 | 13 | 2 | 19.5 | 1.9 | 85 |
| ple 27 | saponified | | | | | | | | |
| | polyvinyl | | | | | | | | |
| | alcohol | | | | | | | | |
| Exam- | completely | 80000 | TC-315 | 100 | 26 | 2 | 19.5 | 3.5 | 80 |
| ple 28 | saponified | | | | | | | | |
| | polyvinyl | | | | | | | | |
| | alcohol | | | | | | | | |
| Exam- | completely | 80000 | TC-315 | 100 | 52 | 2 | 19.6 | 4.9 | 78 |
| ple 29 | saponified | | | | | | | | |
| | polyvinyl | | | | | | | | |
| | alcohol | | | | | | | | |
| Exam- | completely | 145000 | TC-315 | 100 | 13 | 2 | 19.3 | 2.2 | 82 |
| ple 30 | saponified | | | | | | | | |
| | polyvinyl | | | | | | | | |
| | alcohol | | | | | | | | |
| Exam- | completely | 145000 | TC-315 | 100 | 26 | 2 | 19.4 | 3.3 | 79 |
| ple 31 | saponified | | | | | | | | |
| | polyvinyl | | | | | | | | |
| | alcohol | | | | | | | | |
| Exam- | partially | 9000 | TC-300 | 100 | 3 | 10 | 19.1 | 3.1 | 79 |
| ple 32 | saponified | | | | | | | | |
| | polyvinyl | | | | | | | | |
| | alcohol | | | | | | | | |
| Exam- | partially | 30000 | TC-300 | 100 | 26 | 5 | 19.3 | 4.9 | 73 |
| ple 33 | saponified | | | | | | | | |
| | polyvinyl | | | | | | | | |
| | alcohol | | | | | | | | |
| Exam- | partially | 70000 | TC-300 | 100 | 26 | 2 | 19.2 | 5.3 | 75 |
| ple 34 | saponified | | | | | | | | |
| | polyvinyl | | | | | | | | |
| | alcohol | | | | | | | | |
| Exam- | partially | 160000 | TC-300 | 100 | 26 | 2 | 19.5 | 4.7 | 74 |
| ple 35 | saponified | | | | | | | | |
| | polyvinyl | | | | | | | | |
| | alcohol | | | | | | | | |
| Exam- | completely | 145000 | TC-300 | 100 | 13 | 2 | 19.5 | 3.0 | 79 |
| ple 36 | saponified | | | | | | | | |
| | polyvinyl | | | | | | | | |
| | alcohol | | | | | | | | |
| Exam- | partially | 200000 | TC-315 | 100 | 26 | 2 | 19.4 | 4.2 | 76 |
| ple 37 | saponified | | | | | | | | |
| | polyvinyl | | | | | | | | |
| | alcohol | | | | | | | | |
| Exam- | partially | 9000 | TC-315 | 100 | 13 | 10 | 19.3 | 4.3 | 79 |
| ple 38 | saponified | | | | | | | | |
| | polyvinyl | | | | | | | | |
| | alcohol | | | | | | | | |

TABLE 3

| | | | | | | | Measurement results | | |
|---|---|---|---|---|---|---|---|---|---|
| | | | | Proportions | | | | Half- | Capacity |
| | Water-soluble polymer | | | Water- | | | Diffraction | value | retention |
| | Substance | | Crosslinking | soluble | Crosslinking | Cellulose | angle 2θ | width | rate |
| | name | Mw | precursor | polymer | precursor | nanofiber | (°) | (°) | (%) |
| Exam- | partially | 30000 | X-12- | 100 | 7 | 10 | 19.4 | 2.8 | 72 |
| ple 39 | saponified | | 1308ES | | | | | | |
| | polyvinyl | | | | | | | | |
| | alcohol | | | | | | | | |
| Exam- | partially | 30000 | X-12- | 100 | 14 | 2 | 19.5 | 4.1 | 71 |
| ple 40 | saponified | | 1308ES | | | | | | |
| | polyvinyl | | | | | | | | |
| | alcohol | | | | | | | | |
| Exam- | partially | 30000 | X-12- | 100 | 28 | 2 | 19.3 | 4.8 | 69 |
| ple 41 | saponified | | 1308ES | | | | | | |
| | polyvinyl | | | | | | | | |
| | alcohol | | | | | | | | |
| Exam- | partially | 70000 | X-12- | 100 | 7 | 5 | 19.6 | 3.4 | 73 |
| ple 42 | saponified | | 1308ES | | | | | | |
| | polyvinyl | | | | | | | | |
| | alcohol | | | | | | | | |
| Exam- | partially | 70000 | X-12- | 100 | 14 | 2 | 19.7 | 4.0 | 73 |
| ple 43 | saponified | | 1308ES | | | | | | |
| | polyvinyl | | | | | | | | |
| | alcohol | | | | | | | | |
| Exam- | partially | 70000 | X-12- | 100 | 28 | 2 | 19.9 | 5.1 | 68 |
| ple 44 | saponified | | 1308ES | | | | | | |
| | polyvinyl | | | | | | | | |
| | alcohol | | | | | | | | |
| Exam- | partially | 160000 | X-12- | 100 | 14 | 2 | 19.4 | 4.3 | 72 |
| ple 45 | saponified | | 1308ES | | | | | | |
| | polyvinyl | | | | | | | | |
| | alcohol | | | | | | | | |
| Exam- | partially | 160000 | X-12- | 100 | 28 | 2 | 19.4 | 5.3 | 70 |
| ple 46 | saponified | | 1308ES | | | | | | |
| | polyvinyl | | | | | | | | |
| | alcohol | | | | | | | | |
| Exam- | completely | 80000 | X-12- | 100 | 14 | 2 | 19.4 | 1.8 | 74 |
| ple 47 | saponified | | 1308ES | | | | | | |
| | polyvinyl | | | | | | | | |
| | alcohol | | | | | | | | |
| Exam- | completely | 80000 | X-12- | 100 | 28 | 2 | 19.3 | 3.3 | 73 |
| ple 48 | saponified | | 1308ES | | | | | | |
| | polyvinyl | | | | | | | | |
| | alcohol | | | | | | | | |
| Exam- | completely | 145000 | X-12- | 100 | 14 | 2 | 19.4 | 4.2 | 72 |
| ple 49 | saponified | | 1308ES | | | | | | |
| | polyvinyl | | | | | | | | |
| | alcohol | | | | | | | | |
| Exam- | partially | 9000 | X-12- | 100 | 3 | 10 | 19.2 | 3.9 | 69 |
| ple 50 | saponified | | 1309ES | | | | | | |
| | polyvinyl | | | | | | | | |
| | alcohol | | | | | | | | |
| Exam- | partially | 200000 | X-12- | 100 | 26 | 2 | 19.7 | 4.0 | 69 |
| ple 51 | saponified | | 1310ES | | | | | | |
| | polyvinyl | | | | | | | | |
| | alcohol | | | | | | | | |

TABLE 4

| | | | | | | | Measurement results | | |
|---|---|---|---|---|---|---|---|---|---|
| | Water-soluble | | | Proportions | | | | Half- | Capacity |
| | polymer | | | Water- | | | Diffraction | value | retention |
| | Substance | | | soluble | Crosslinking | Cellulose | angle 2θ | width | rate |
| | name | Mw | Crosslinking precursor | polymer | precursor | nanofiber | (°) | (°) | (%) |
| Exam- | partially | 30000 | blocked 4,4-diphenylmethane | 100 | 9 | 10 | 19.5 | 3.7 | 65 |
| ple 52 | saponified | | diisocyanate (MDI) | | | | | | |
| | polyvinyl | | | | | | | | |
| | alcohol | | | | | | | | |
| Exam- | partially | 70000 | blocked 4,4-diphenylmethane | 100 | 18 | 5 | 19.4 | 4.0 | 67 |
| ple 53 | saponified | | diisocyanate (MDI) | | | | | | |
| | polyvinyl | | | | | | | | |
| | alcohol | | | | | | | | |
| Exam- | partially | 160000 | blocked 4,4-diphenylmethane | 100 | 36 | 2 | 19.6 | 4.8 | 66 |
| ple 54 | saponified | | diisocyanate (MDI) | | | | | | |
| | polyvinyl | | | | | | | | |
| | alcohol | | | | | | | | |
| Exam- | completely | 80000 | blocked 4,4-diphenylmethane | 100 | 36 | 2 | 19.3 | 4.2 | 69 |
| ple 55 | saponified | | diisocyanate (MDI) | | | | | | |
| | polyvinyl | | | | | | | | |
| | alcohol | | | | | | | | |
| Exam- | completely | 145000 | blocked 4,4-diphenylmethane | 100 | 36 | 2 | 19.5 | 4.5 | 68 |
| ple 56 | saponified | | diisocyanate (MDI) | | | | | | |
| | polyvinyl | | | | | | | | |
| | alcohol | | | | | | | | |
| Exam- | partially | 30000 | blocked 1,3,5-tris(6- | 100 | 48 | 2 | 19.4 | 5.5 | 66 |
| ple 57 | saponified | | isocyanatohexyl)biuret | | | | | | |
| | polyvinyl | | | | | | | | |
| | alcohol | | | | | | | | |
| Exam- | partially | 70000 | blocked 1,3,5-tris(6- | 100 | 24 | 2 | 19.2 | 4.8 | 68 |
| ple 58 | saponified | | isocyanatohexyl)biuret | | | | | | |
| | polyvinyl | | | | | | | | |
| | alcohol | | | | | | | | |
| Exam- | partially | 160000 | blocked 1,3,5-tris(6- | 100 | 24 | 2 | 19.7 | 4.5 | 69 |
| ple 59 | saponified | | isocyanatohexyl)biuret | | | | | | |
| | polyvinyl | | | | | | | | |
| | alcohol | | | | | | | | |
| Exam- | completely | 80000 | blocked 1,3,5-tris(6- | 100 | 24 | 2 | 19.6 | 4.0 | 72 |
| ple 60 | saponified | | isocyanatohexyl)biuret | | | | | | |
| | polyvinyl | | | | | | | | |
| | alcohol | | | | | | | | |
| Exam- | completely | 145000 | blocked 1,3,5-tris(6- | 100 | 24 | 5 | 19.4 | 4.3 | 70 |
| ple 61 | saponified | | isocyanatohexyl)biuret | | | | | | |
| | polyvinyl | | | | | | | | |
| | alcohol | | | | | | | | |
| Exam- | partially | 70000 | blocked 1,3,5- | 100 | 12 | 10 | 19.5 | 3.5 | 66 |
| ple 62 | saponified | | tris(isocyanatomethyl)benzene | | | | | | |
| | polyvinyl | | | | | | | | |
| | alcohol | | | | | | | | |
| Exam- | completely | 80000 | blocked 1,3,5- | 100 | 24 | 2 | 19.2 | 4.0 | 68 |
| ple 63 | saponified | | tris(isocyanatomethyl)benzene | | | | | | |
| | polyvinyl | | | | | | | | |
| | alcohol | | | | | | | | |
| Exam- | completely | 145000 | blocked 1,3,5- | 100 | 24 | 2 | 19.6 | 3.8 | 67 |
| ple 64 | saponified | | tris(isocyanatomethyl)benzene | | | | | | |
| | polyvinyl | | | | | | | | |
| | alcohol | | | | | | | | |
| Exam- | partially | 8000 | TC-315 | 100 | 26 | 5 | 19.3 | 5.2 | 64 |
| ple 65 | saponified | | | | | | | | |
| | polyvinyl | | | | | | | | |
| | alcohol | | | | | | | | |
| Exam- | partially | 250000 | X-12-1310ES | 100 | 13 | 2 | 19.9 | 5.0 | 65 |
| ple 66 | saponified | | | | | | | | |
| | polyvinyl | | | | | | | | |
| | alcohol | | | | | | | | |
| Compar- | completely | 80000 | — | 100 | 0 | 0 | 19.4 | 1.8 | — |
| ative | saponified | | | | | | | | |
| Exam- | polyvinyl | | | | | | | | |
| ple 1 | alcohol | | | | | | | | |
| Compar- | completely | 80000 | — | 100 | 0 | 25 | 19.4 | 1.8 | 35 |
| ative | saponified | | | | | | | | |
| Exam- | polyvinyl | | | | | | | | |
| ple 2 | alcohol | | | | | | | | |
| Compar- | completely | 80000 | TC-315 | 100 | 70 | 25 | 20.0 | 7.5 | 20 |
| ative | saponified | | | | | | | | |
| Exam- | polyvinyl | | | | | | | | |
| ple 3 | alcohol | | | | | | | | |

TABLE 5

| | | | | | | | Measurement results | | |
|---|---|---|---|---|---|---|---|---|---|
| | Water-soluble | | | Proportions | | | | Half- | Capacity |
| | polymer | | | Water- | | | Diffraction | value | retention |
| | Substance | | | soluble | Crosslinking | Cellulose | angle 2θ | width | rate |
| | name | Mw | Crosslinking precursor | polymer | precursor | nanofiber | (°) | (°) | (%) |
| Exam- | polyacrylic | 150000 | TC-315 | 100 | 3 | 10 | 17.1 | 3.4 | 71 |
| ple 67 | acid | | | | | | | | |
| Exam- | polyacrylic | 150000 | TC-300 | 100 | 13 | 5 | 17.2 | 3.8 | 72 |
| ple 68 | acid | | | | | | | | |
| Exam- | polyacrylic | 150000 | X-12-1308ES | 100 | 3 | 10 | 16.9 | 3.5 | 75 |
| ple 69 | acid | | | | | | | | |
| Exam- | polyacrylic | 150000 | blocked 4,4-diphenylmethane | 100 | 5 | 10 | 17.7 | 3.9 | 72 |
| ple 70 | acid | | diisocyanate (MDI) | | | | | | |
| Exam- | polyacrylic | 150000 | 1,3,5- | 100 | 3 | 10 | 17.6 | 4.6 | 75 |
| ple 71 | acid | | tris(isocyanatomethyl)benzene | | | | | | |
| Exam- | polyacrylic | 150000 | 1,3,5-tris(6- | 100 | 12 | 2 | 18.0 | 4.7 | 78 |
| ple 72 | acid | | isocyanatohexyl)biuret | | | | | | |

The lithium ion secondary batteries using the binders according to Examples 1 to 72 exhibited a higher capacity retention rate and higher cycle characteristics even after 200 cycles than those of Comparative Example 1 to Comparative Example 3. In Comparative Example 1, the binder had no electrolytic solution resistance, and the battery characteristics could not be evaluated. In Comparative Example 2 and Comparative Example 3, the mechanical strength of the binder was not sufficient, and sufficient cycle characteristics were not obtained.

### REFERENCE SIGNS LIST

1 Binder
2 Water-soluble polymer
3 Crosslinking agent
4 Cellulose nanofiber
5 Crosslinking precursor
10 Separator
20 Positive electrode
22 Positive electrode current collector
24 Positive electrode active material layer
30 Negative electrode
32 Negative electrode current collector
34 Negative electrode active material layer
40 Power generating element
50 Exterior body
52 Metal foil
54 Resin layer
60, 62 Terminal
100 Lithium ion secondary battery

1. A cured product for lithium ion secondary batteries, comprising water-soluble polymers, a crosslinking agent and cellulose nanofibers,
wherein the crosslinking agent crosslinks different water-soluble polymers or the water-soluble polymer and the cellulose nanofibers,
when wide-angle X-ray scattering (WAXS) measurement is performed using CuKα rays, the diffraction angle 2θ has a peak in a range of 16° or more and 21° or less, and
the half-value width of the peak is 5.5° or less.

2. The cured product for lithium ion secondary batteries according to claim 1,
wherein the water-soluble polymer is any one selected from the group consisting of polyvinyl alcohol, carboxymethyl cellulose, methyl cellulose, a copolymer of acrylic acid and vinyl alcohol, and polyacrylic acid.

3. The cured product for lithium ion secondary batteries according to claim 1,
wherein the crosslinking agent is a compound obtained by dissociating a blocking agent from any one selected from the group consisting of a blocked isocyanate silane compound, a blocked diisocyanate compound, and a blocked triisocyanate compound or a titanium compound.

4. The cured product for lithium ion secondary batteries according to claim 1,
wherein the water-soluble polymer has a weight average molecular weight of 9,000 or more and 200,000 or less.

5. A negative electrode for lithium ion secondary batteries comprising a negative electrode active material and the cured product for secondary batteries according to claim 1.

6. A lithium ion secondary battery comprising the negative electrode for lithium ion secondary batteries according to claim 5, a positive electrode, and a separator between the negative electrode for lithium ion secondary batteries and the positive electrode.

7. The cured product for lithium ion secondary batteries according to claim 1,
wherein the cellulose nanofibers have the average fiber length of 0.1 μm or more and 1,000 μm or less.

8. The cured product for lithium ion secondary batteries according to claim 1,
wherein the cellulose nanofibers have the average fiber diameter of 1 nm or more and 10 μm or less.
